(19) United States
(12) Patent Application Publication
(10) Pub. No.: US 2007/0011089 A1
(43) Pub. Date: Jan. 11, 2007

(54) Electronic savings transfers

(76) Inventor: Michelle E. DeSchryver, Rocklin, CA (US)

Correspondence Address: MCDONOUGH, HOLLAND & ALLEN, 555 CAPITOL MALL, 9TH FLOOR, SACRAMENTO, CA, 95814, US

(21) Appl. No.: 11/483,468

(22) Filed: Jul. 8, 2006

Related U.S. Application Data
(60) Provisional application No. 60/697,410, filed on Jul. 9, 2005.
(60) Provisional application No. 60/703,939, filed on Jul. 29, 2005.

(51) Int. Cl. G06Q 40/00

(52) U.S. Cl. 705/39; 705/35

(57) ABSTRACT

A system and method is provided for directing the transfer of funds to a customer designated account at a electronic payment system terminal, the method comprising the steps of: a) establishing a customer designated account capable of being accessed through the transaction processing system associated with a merchant, where the transaction processing system is communicatively linked to the customer designated account; b) accessing identifying data relating to the customer designated account through an electronic payment system terminal communicatively linked to the transaction processing system; c) automatically generating an electronic savings prompt for a customer at the electronic payment system terminal; and d) in response to a positive customer input to the savings prompt establishing a connection to the customer designated account and transferring funds into the customer designated account.

### BACKGROUND OF THE INVENTION

1. Field of the Invention

The present invention relates to the field of customer savings programs and merchant incentives.

2. Description of Related Art

According to US Census data, middle-income Americans are experiencing at time of substantially decreased personal savings, partly due to the reduction of earnings in inflation-adjusted real terms. The statistics also show that self-employment rates, overall expenditures, credit card debt and bankruptcies (both businesses and personal) continue to rise each year.

In particular, contributions to corporate sponsored 401K, profit sharing and personal savings programs have significantly decreased. Less than half of baby boomers surveyed today have a retirement savings, often because they're unable to set money aside. Today, consumers and communities face many instabilities and uncertainties of the economy including job security, inadequate health benefits, concern for the future of social security, accrued debt and aging parents.

One form of savings that consumers are presented with are the variety of customer loyalty and rewards programs, though consumers (and merchants) are inundated with both online and in-store rewards programs and solicitations, as well as third party marketers and a network too large to adequately accommodate fulfillment and customer service. The result is confusion, undelivered promises, omissions and contingencies and a sheer lack of accountability as to the rewards due to them and by whom, where and when. Consumers may sign their same card with many rewards programs in the hope of accruing gifts and rebates for themselves or their loved ones, and make purchases based on the promised “rewards” rather than the actual (often inflated) purchase prices.

With this surge of rewards programs and offers there comes a series of tantalizing credit card offers promoted on many sites. Many of these are laden with high-interest and subprime rates, fees and service charges; certain to escalate consumer debt and negate any “rewards.” Additionally, online personal information is required, with concerns over internet security increasing the risks of identity theft.

Despite all of this, the number one complaint found on the internet is that consumer's rebates for college funding (and other rewards) are not being delivered. The consumer is often confronted with a legal and generic letter of explanation to the consumer as to why a particular purchase was not a “qualified” purchase. Most reward programs are run by for profit organizations. The percentage of rebate promised the consumer is typically 5 to 20%. The marketing company hosting the rewards programs (whose bank account monies are deposited) typically receives from 20 to 50% plus other occasional benefits such as profit sharing. Some contribute an undisclosed amount to charity to qualify for merchant's tax deductible donations; often as low as 2 percent.

There was a very common explanation when consumers were interviewed and asked as to why they continue to participate in rewards programs, given their frustrations, debt and disappointment. The reason was because it offered them the hope and possibility that the promised rewards would materialize and help them to save money, with retirement and college savings being among the greatest expressed fears, though these were found to be the programs with the least success.

Surveys reflect, however, that as much as anything consumers desire personal retirement savings accounts and, further, that they prefer investing independently. For most consumers, however, this proves to be impossible without an affordable, accessible and non-qualifying vehicle/option to do so. When provided the opportunity, consumers have shown they are able to determine and execute personal contributions and to able to track and monitor their accounts on-line.

Several approaches have been adopted by the marketplace to provide consumers the incentive to contribute and save money. One such system provides consumers with an automated way for sales establishments to extend point of sale (POS) or point of purchase (POP) cash transactions to allow consumers to save change or transfer discretionary funds into saving or donating accounts managed by a central clearinghouse. U.S. Pat. No. 6,088,682, Burke, describes a network composed of consumer/payors with identification cards and merchants that are required to enter data and funds into remote POS terminals, which are then processed by a central clearinghouse.

One disadvantage to existing programs and systems is the reliance in such systems on automated clearing house (ACH) systems for making the electronic finds transfer. Additionally, the systems are cumbersome to install and follow, making it difficult for the ordinary consumer to sign up for a program or remember to participate.

In one program, Bank of America's Keep the Change® program, the customer must register at an in-store bank for physical customer service and/or enrollment in a savings program. This program further requires that the customer either have or establish both a checking and a savings account with the bank, reducing the choices to the customer. Further, the customer is not provided with many options, only a transfer from one bank account to another.

Credit card EFT savings incentives similarly are restricted in requiring the customer to own a credit card with fees and the assume debt that that entails.

In a program developed by Every Penny Counts®, contributions may be made for the benefit of non-profits, such as through the purchase of scrip. Contributions are thereby facilitated from for-profits to non-profits (fundraising), though this program does not provide the means for customer to save for personal retirement. This program also does not accommodate cash contributions at the point of sale, but only provides for the rounding up of sales transactions.

The UPromise store rebates system makes contributions to 529 college plan savings by merchant-rebated finds deposited into zero-interest trustee accounts that are not controlled by the customer, and are not even a true 529 plan, as such a plan requires another process/application and entity to hold such accounts. Further, in this program the customer must register personal debit card and allow access to checking/bank account, which requires a debit card with checking and savings account registered and linked. Another problem with the program is that if money is not claimed within maximum one year term, the funds are lost.

Other “rewards” and “loyalty” programs offer store cash rebates (versus points, gifts, travel, etc.), though many of those require the use of a particular co-branded credit card for “qualified” purchases. Such programs tend to be ever-changing, with a series of funds transfers through various locations, that make the program confusing and virtually impossible to track for the average consumer. The rebates tend to be received only on (ever-changing) “qualified purchases” and subject to change, terms and conditions which there are many. Further, the average rebates are in the range of 1%-5%, yet stores charge interest rates in the range of 18%-20% (or higher fees) on branded credit cards (often after promoting 0% interest (or no fees) for a very limited trial period).

Merchants receive an average of 20% manufacturer cash rebates per transaction (on wholesale prices) which is often “rewarded” in part to customers and discounted at POS. Yet surveys show that customers prefer 5% cash back to 20% in product discounts (often distrustful of initial pricing mark ups to offset real or imagined POS discounts). Hence, stores could retain more profit and fulfill customer needs/preferences.

Another problem is that such programs require active initiation of a savings transaction by the consumer. Also, in these systems, funds are electronically transferred to a clearinghouse or through sweep accounts, where they are maintained for a time until the consumer is able to further direct the movement of investment of these funds.

There remains a need, therefore, for a practical, easy to use in-store savings program that can help the

### SUMMARY OF THE INVENTION

A system and method is provided for directing the transfer of funds to a customer designated account at a electronic payment system terminal, the method comprising the steps of:

a) establishing a customer designated account capable of being accessed through the transaction processing system associated with a merchant, where the transaction processing system is communicatively linked to the customer designated account;

b) accessing identifying data relating to the customer designated account through an electronic payment system terminal communicatively linked to the transaction processing system;

c) automatically generating an electronic savings prompt for a customer at the electronic payment system terminal; and

d) in response to a positive customer input to the savings prompt establishing a connection to the customer designated account and transferring funds into the customer designated account.

In one preferred embodiment in step b) the electronic payment system terminal is a point of sale terminal at a merchant, while in a different such embodiment in step b) the electronic payment system terminal is an ATM machine.

In a another aspect, in step d), the funds comprise a debit contribution from a personal account of the customer. In one preferred embodiment in step d), the funds further comprise an incentive contribution from the merchant. In a different preferred embodiment in step d), the funds comprise a cash contribution.

In another preferred embodiment the cash contribution is in addition to a purchase price in a sales transaction between the customer and the merchant.

In a separate preferred embodiment in step a) connectivity to the customer designated account is established by electronic integration into software of the transaction processing system.

In a preferred embodiment electronic the software integration comprises software capable of being integrated into the transaction processing system.

In another preferred embodiment electronic the software integration comprises adapting software of the transaction processing system.

In still further preferred embodiment in step b) the identifying data is located on a card selected from the group of cards consisting of ATM, driver license, merchant loyalty card or a prepaid, reloadable VISA/MC.

Preferably, the customer designated account is an account at a bank having a branch within the merchant. In one such preferred embodiment the customer designated account is a savings account.

In a different preferred embodiment the customer designated account is a retirement account, such as a 401K account, a 529 account, a mutual fund or an IRA account.

In a preferred embodiment the customer designated account is an account attached to a whole life insurance policy.

In another preferred embodiment in step a) establishing a customer designated account comprises pre-registering for the customer designated account via the merchant.

In a different preferred embodiment registering for the customer designated account is in response to prompts generated at the point of sale.

In another preferred embodiment in step a) establishing a customer designated account comprises registering for the customer designated account via a bank.

In a different aspect, in step c) the prompt preferably comprises an option of transferring s specific amount of money into the customer designated account.

In a still different aspect, in step c) the prompt preferably comprises an option of transferring a percentage of a transaction amount into the customer designated account. In further aspect in step c) the percentage relates to the sales tax percentage for the transaction.

In another preferred embodiment in step c) the prompt comprises an option of transferring the difference between the transaction amount and a higher amount.

In a preferred embodiment in step c) the prompt comprises an option of transferring an amount according to a calculation method pre-selected by the customer at the time of establishing the customer designated account in a).

### BRIEF DESCRIPTION OF THE DRAWINGS

Various exemplary embodiments of this invention will be described in detail, with reference to the following figures, wherein:

FIG. 1 provides a diagram demonstrating the elements of the savings method and system.

### DETAILED DESCRIPTION OF THE PREFERRED EMBODIMENT

The invention provides a method and system for making electronic savings transfers (the “Electronic Saving Transfer system”, or “the EST system”). The EST system provides customers with an accessible venue to save money for their retirement, via direct electronic savings transfers of funds through existing electronic payment systems. For the customer, the EST system makes personal contributions affordable and predictable.

The EST system involves the use of electronic prompts directed to a customer at a retail or merchant point of sale, providing the customers with a link which will both remind and allow the customer at the time of making a purchase that they may direct amounts into customer designated accounts, such as bank savings accounts.

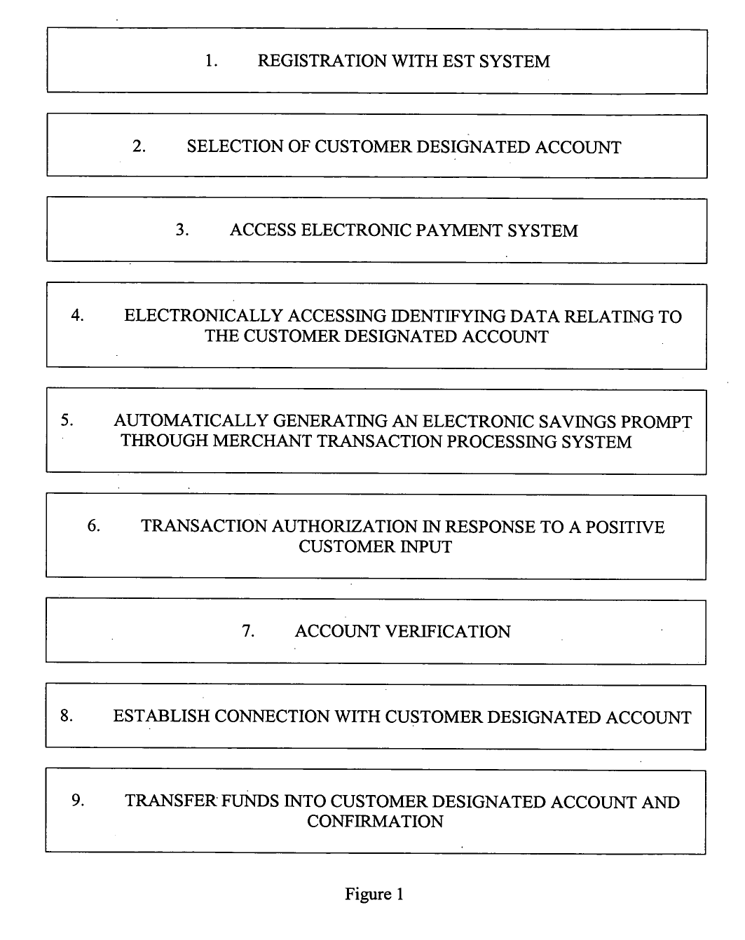

In reference to FIG. 1, there is presented a diagram for one method implementing a transaction through the EST system. In step 1 of FIG. 1, registration with EST system is accomplished when a customer enrolls, for example, online for an EST program using an EST licensed or otherwise affiliated website. Customers can acquire and/or link rewards cards for activation at the POS (when swiping and accepting the terms and conditions proceeding cash-prompts and savings transfer option.

It is envisioned that the steps that a consumer may take to enroll in the EST system are preferably conducted online, either at home via an EST related website (template), or at a merchant location using a secure in-store kiosk which resembles an in-store employment application kiosk or wedding registry kiosk.

In-store bank, internet ready desktop and/or self service kiosks allow customers immediate access to opening savings accounts, with immediate card activation, and loyalty card issuance. They can also be adapted for non-POS cash savings contributions and/or account reference that will reduce the risk and loss of customers who leave the store to enroll online from home or by mail/phone.

The EST system does not require that the customer have or establish a checking account—although they have the option to link and transfer cash directly from their checking account using their debit card or e-check

In step 2, during selection of the customer designated account, the customer may register with any form of identification, even using a driver's license to enable cash EST transaction payments at the POS. Customer typically will also register and link to a new or existing checking account, allowing debit card EST payments to be made to the designated account. As one example, when registering the customer selects a preferred bank as the originator of a newly established EST registered savings account, perhaps because he shops at a particular merchant frequently and likes having the comfort and convenience of that merchant's in-store bank for its physical presence, customer service and other one-stop services.

In step 3 the customer accesses an electronic payment system terminal when the customer goes to a merchant where he can use his EST registered ATM/debit card to pay for his merchandise and simultaneously make an EST deposit at the POS terminal. The merchant will display an EST related logo for its customers on their entrance doors, at their in-store banks, at the point-of-purchase register and on the terminal. The EST savings options & message prompts are also visually displayed & advertised on the terminal screen whenever the electronic payment system is utilized.

At step 4 identifying data relating to a customer designated account is electronically accessed when the customer submits his registered information, for example, by swiping an ATM/debit card at the merchant's POS terminal in a checkout line. Most typically, this occurs when the customer presses the button which says “ATM” or “Debit” and, when prompted, enters his personal identification number (PIN).

In step 5, an electronic savings prompt is automatically generated and linked to the merchant's transaction processing system. The merchant's transaction processing system ensures that the PIN is encrypted for security, and then sends an electronic message to the central network through the store's processing system. Once authenticated (please note that unless otherwise restricted by the merchant, a purchase is not necessary to make an EST transaction) an EST automated prompt is then displayed (before, after or in lieu of “cash back”) and the customer chooses amongst the EST savings transfer buttons/options visible on the screen. When electronically and visually prompted at the POS terminal, the customer may have as many payment options from which to transfer and deposit into his EST designated account (or accounts) as were set up and made possible at the time of registration. When applicable, the customer may also receive offers, such as for a participating merchant/manufacturer's cash-rebated contributions.

Step 6 occurs in response to the customer selecting a positive response to the prompt, such as, for example, selecting the “Round Up” option provided at the terminal. Whatever the selection, the corresponding amount is added to the transaction totals for electronic processing and approval. He is asked again to verify and authorize the transaction amount.

Step 7 is account verification. Typically, the network sends an electronic message to the bank's processor to “authorize” the transaction, i.e., to make sure there are sufficient funds in the checking account and that the PIN is correct. If the customer did not have a checking account with the bank or the checking account was not set up to be accessed with his ATM/debit card, the transaction would be denied. The bank's processor then returns a message through the network (e.g., STAR) that indicates whether the customer has enough in the checking account to buy the merchandise and make the selected EST deposit. The amount of the customer's purchase, which includes the EST cash amount, is debited from his checking account. The debit to his account happens either immediately (typical with wire transfers) or may occur later the same day. In any case, the transaction will typically by viewable online through the bank's web-site. When account is debited will depend on the bank processor, not on the merchant.

In step 8, a connection is established between the merchant's transaction processing system and the customer's designated account, as designated at registration.

Step 9 finalizes the EST transaction with the transfer of finds into the customer designated account, and confirmation. The network then forwards the result back to the merchant's transaction processing system and the POS terminal with confirmation to let the customer know the EST transaction has been approved. The detailed transaction is printed on receipt.

The EST system provides the first interactive POS electronic customer savings program which requires the customer's physical input, and the only program which allows the customer to make and manage personal cash contributions (versus rebates, rewards or credit card cash back incentives) for their transfer/deposit.

For the operation of an EST system in a basic pin secured ATM transactions, the customer may open an EST savings account at a bank, for example, where the customer has an existing checking account, with a link to the customer's debit card.

Whenever the customer then goes to an ATM of that bank for cash an additional savings prompt is added to the transaction. Typically, the customer puts his ATM/debit card into a bank ATM, and, when prompted, enters the personal identification number (PIN) attached to that account. The customer than inputs an amount, for example $20.00, for cash.

Before this cash is withdrawn, or possibly after, an EST prompt is created asking the customer whether to make EST. He chooses an amount here, for example, $5.00, to transfer.

The banks processor then ensures that the PIN is encrypted for security, and sends an electronic message through the ATM Network, first to the bank issuing the ATM to “authorize” the transaction, in other words, to make sure there are sufficient funds in the account and that the PIN is correct.

When the amount of cash that the customer has requested is approved and debited from the authorizing account the processor returns a message to the ATM network allowing the transaction. The ATM network forwards the information to the processor for the bank ATM, which activates the appropriate cash drawer on the ATM. The customer receives, in this example, $20.00 cash withdrawal, and confirmation of the $5.00 EST is shown on the receipt.

As some time later, the ATM network provides settlement between the ATM bank and the customer bank for the withdrawn amount, and the amount that the customer transferred into his EST account.

There are many other such scenarios for ATM transactions that are more complex. In general, however, an entire ATM transaction happens in 10 seconds or less.

The examples above provides an overview of how EST deposits using PIN-secured debit works. However, an EST transaction can also be established in the context of a reverse transaction of a “CASH BACK” situation, where rather than the cashier giving a selected amount of CASH BACK to the customer to be placed in a wallet and subsequently spent, it is retained by the cashier for an EST transaction on behalf of the customer. It is transferred securely, and depending on which ACH or wire option is implemented, the customer's money is electronically transferred directly from the customer's designated account. The transaction may also process though an additional EFT transfer that occurs instantaneously from the store's bank to the customer's bank.

A customer may also use a non-monetary ID card such as a loyalty card or drivers license as identity verification, for example a cash or a prepaid cash card may be linked to a customer designated savings account in order to allow an EST deposit at the POS/POP terminal (simultaneously or independently of purchase). For this situation, at the merchant POS/POP terminal a cash or cash/gift card paying customer requests an EST transaction from the cashier. The cashier inputs manually or scans customer's ID or rewards card- or customer swipes/scans card through electronic payment terminal which initiates prompts for the EST system. The customer then chooses, for example, a $10.00 button from the EST visual prompts on the EPS terminal screen. The customer then pays the cashier, for example, $5.00 cash, or has it debited from the prepaid cash card. The money is transferred directly to the customer's designated account, for example, a Roth IRA or other designated savings/insurance account, and the deposit is printed on the receipt issued for the transaction.

The electronic terminal prompts provide by the EST system serve as a regular reminder to the customer to invest The EST system encourages the investment of incremental amounts, and relieves the consumer of the need to plan ahead or remember to make specific contributions on a timely basis, or large contributions on an annual, semi-annual or quarterly basis. In doing so, savings are created without incurring financial hardships, lump sum payments/requirements and/or the stringent qualifiers associated with most present-day retirement savings accounts.

The EST system thus provides consumers with automated methods of saving money for retirement (and/or college, insurance, rainy day funds, etc.), allowing them first and foremost to make modest and frequent personal contributions, simultaneously to other everyday electronic payments and transactions.

Merchants and other institutions/contributors may provide a source of secondary funds, as part of various incentive and preferred customer programs, such as rebate, price matching and other related programs. In addition to the valuable time and money-saving features and benefits of the consumer, then, the multiple venues for which customers can directly and effectively accumulate money for their retirement, provides the merchant with an opportunity to create customer loyalty and generate publicity or advertising for the merchants.

The EST system provides systems and methods that provides customers with the most effective means for making regular contributions to their retirement, in the form of an electronic payment system terminal, such as automated point of sale (also “POS”) electronic terminal prompts offering incremental cash options to personally, directly and electronically save money. b) accessing identifying data relating to the customer designated account at an electronic payment system terminal communicatively linked to the transaction processing system.

The EST system for providing for directing the transfer of money to a customer designated account at the location of a merchant transaction processing system, typically an electronic terminal at a point of purchase or point of sale. The point-of-purchase may also be located at a store register, or at a separate kiosk or transaction center, such as a or ATM, online, telephone, etc.

As indicated above, in registering for participation in an EST program, the first step comprises establishing a customer designated account capable of being accessed through the transaction processing system of a merchant, where the transaction processing system is communicatively linked to the customer designated account.

At the time of registration, the customer will typically be asked to choose and authorize either “fixed, reoccurring EST contributions” similar to BILL-PAY or “one-time, per diem” EST contributions similar to CASH-BACK transactions. Any option can be modified or added/removed at any time. Re-occurring options involve automated contributions performed with every transaction (such as double the tax, rounding-up or a percentage of sale). Per diem options involve the investment of incremental amounts and/or some of the above options on a case-by case basis.

The registration website can also act as a “gateway” to customers, enabling the EST system to track, count and monitor customer activity, sales, revenues and reports, and refers/links customers to in-store bank center or online designated bank to enroll. A website “gateway” may incorporate many other innovative online banking, investment, financial, insurance and savings plans, creating a seamless integration with links to banks/stores sites participating in the EST program. The customer “passes through” the EST system's website- and is knowingly redirected to a supermarket bank website, designated bank(s) and/or store(s). They, in turn, offer the services and respond to the customer's needs.

After a designated account is established, whenever a customer is identified at a participating merchant location, identifying data relating to the customer is accessed at a POS customer terminal, that is communicatively linked to the transaction processing system of the merchant. A debit card, a merchant loyalty card, or a prepaid, reloadable VISA/MC, or even a driver's license, may be the source of the identifying data. In some cases a specially issued EST system “deposit” card may be used, versus a debit card, etc. Preferred are magnetic, smart cart PIN type card systems, though other computer readable methods are also suitable, such as scan/swipe contact or contact-less, RFID, biometric signatures/fingerprints/etc.

Off-line transactions and other methods of electronic transactions, such as e-checks, prepaid or gift cards, which include non-monetary or value-added loyalty/rewards programs with/without the visa or m/c debit logos, driver's license and/or any other identification card) can also be used with the EST system.

The EST system may also be elicited upon manual input of identifying information, such as keying in a phone number by cashier or customer keypad.

Once the identification of the customer with the designated account is made, an electronic savings prompt is automatically generated by the transaction processing system and displayed to the customer, such as at a keypad terminal, and, in response to a positive input to the savings prompt, the EST system establishes a connection to the customer designated account and transfers funds into the customer designated account.

The EST system thus provides customers with a simple and regular electronic and automated venue for small and frequent transactions of funds to savings, securely and privately. This is provided in the same convenient transaction as regular retailing transaction or purchase, allowing customers to personally and conveniently transfer funds into their designated account from the POS checkout.

Electronic message prompts can be used on a per diem or per transactional basis, or registrants may choose auto contributions. EST system payment options may include, but are not necessarily limited to:

“DOUBLE TAX” whereby the customer contributes an amount equal the tax of each transaction;

“TAX ROUND UP” whereby the tax is rounded off; in California, the tax is 7.50%, whereby the customer would automatically contribute 0.50% to “round it up” to 8%;

“TRANSACTIONAL ROUND UP” whereby the transaction total is automatically and electronically rounded up to the nearest dollar (noted on receipt) and the difference is transferred to the customer's savings. If the customer's total purchase was $9.10, the customer pays (cash or debit), 10.00 and contributes $0.90;

“POS CASH REWARDS” for merchant contributions;

“HSA SAVINGS CONTRIBUTIONS”, whereby the customer swipes his Insurance card and the HSA approved item cash discounts are contributed to their Health Savings Account;

“POS PROMPTS”, where the customer is presented with the option to “Save Cash” or the like, typically with options presented. The customer decides at the POS terminal and elects the amount from the prompted incremental amounts, which (if any) he/she can afford at that particular time. For example, the prompt may offer an array of choices, such as the amounts of $10.00, $20.00, $25.00 and $50.00. The customer then authorizes the transaction (similar to “cash back” prompt) and funds are electronically transferred to their designated linked savings account. A variation on the POS prompts option is to prompt the customer to “fill in the blank”, allowing any dollar amount of his/her own choosing when at participating POS terminals.

Alternatively, a customer may elect a more automated system at the time of pre-registration, choosing a scheduled and/or recurring, fixed dollar amount/percentage to save with each transaction (such as $1.00 per transaction, $10.00 for each day, 5%, etc). This pre-designated amount is automatically added into each purchase (or even deducted from electronic paycheck deposits), transferred and credited to the customer's customer designated account (per their request). In this way, the EST system allows the consumer to apparently save and contribute retirement monies from “expenses” rather than income.

Any prompt or transfer option can be made an add on to the other. For instance, the fill in the blank option may be in addition to the incremental cash options, where the prompt would offer the payment option of “other amount” and customer would subsequently add in that amount.

In any case, the transfers to the customer-designated account are itemized on the customer's receipt and/or made available to the customer online (restrictions and maximums may apply, as do other bank/industry laws).

It is easy to see how the EST system can result in many small, affordable, frequent and definitive contributions with cash and other electronic forms of payments (including debit/credit card, prepaid cards, electronic checks, prepaid rewards cards with or without debit card privileges, etc.) at a POS prompted terminal (including automatic teller machines, e-commerce, m-commerce, PDA, telephone, fax, etc); without the disparities, contingencies or uncertainties associated with other “rewards” programs.

A customer designated account refers to any customer account to which money can be transferred for the purpose of saving, including a savings account and investment accounts. These include, but are in no way limited to, accounts such as a 401(k) accounts, 529 accounts, mutual funds, etc.

The customer designated accounts may also be accessed by the customer via self-service in-store kiosks or in-home store/bank integrated websites. In this fashion the customer may access the account through the internet, both for ready enrollment and activation to open a new savings account for the EST system, or to register and/or activate an ID card to be associated with an account (i.e., driver's license, existing or new loyalty card, debit card, etc.).

Alternatively, accounts may be set up through self-service kiosks. These may be fitted with optional biometric security and/or encrypted digital signature/certificates for immediate use/activation and issue, or, optionally, may be authorized through a private or centralized network and bank

Where the customer designated account is linked to the merchant or in-store bank, the EST statements and website content can be used to provide customers with information about store events or other services or products of the merchant or bank, as well as news and information that is both relevant and diversified for the consumer, including educational, informational and inspirational resources, links and referrals. The EST system website can thus be used to access the account holders with information, for example, on daily competitive pricing (via price comparisons), (novice) investment opportunities and real time account information, e-commerce and in-store shopping tools, aids, health and wellbeing, and information to help customers save money- and make money. Optionally, it may contain confidential and interactive retirement information, enabling customers to access a wealth of goal setting and retirement/investment strategies based on their personal criteria and circumstances.

Merchants may also opt to match their customers contribution, in addition to—or in lieu of—price matching or other promotional or incentive programs, which amounts are also rebated and deposited into customer designated accounts.

The EST system allows the customer to make convenient (ACH direct deposits, wire transfers, or internal fund transfers to in-store banks) payments to his or her designated bank account (savings, investment or insurance, HSA, etc.) using either cash or other form of payment. This is all accomplished from a merchant's location, such as a point of sale terminal (ATM or other electronic payment system), and can be conveniently accomplished simultaneous to other transactions.

The EST system links directly into the established banking networks, allowing the customer to securely transfer/deposit funds into the customer's (in-store or other) bank account simultaneously to paying for goods and services purchased on in stores or online. The service can be made to be free to the customer, i.e., the merchants pay the small transaction fees.

EFT is a generic term for electronic funds transfers, and describes two different methods of transferring funds electronically, namely, wire transfer and ACH. Though each is handled by different departments at a bank, and both are performed through Federal Reserve Bank System (except for “in-bank” or “on-us” transactions) an ACH payment is not truly a wire transfer. EFT (PIN secured debits using ACH or money WIRES) are among the fastest types of transactions to perform.

Wire transfer is a legal term that refers to the movement of money from account to account, or from person to person, by electronic means. The physical cash itself does not necessarily move at all, just the ownership of the money is transferred. There are various ways in which EFT information is received and sent, with one of the most common being the FedWire. Funds transferred electronically are available immediately.

Banks are usually involved in some form of electronic finds transfer (EFT). EFT is defined as any transfer of funds which is initiated through an electronic terminal, telephonic instrument, computer or magnetic tape so as to order, instruct or authorize a financial institution to debit or credit an account. The most common forms of EFT are wire transfers, and automated clearing house (ACH), automatic teller machines (ATM) and point of sale (POS) transactions. Some of the newer types of EFT transactions include telephone bill paying, home banking systems and debit cards.

Wire transfer is an increasingly popular method for various banking transactions, such as credit card balance transfers, personal account management, e.g., transferring finds from a savings account into a checking account and ATM-card purchases at the POS. Each debit transaction with an ATM card authorizes, in a sense, a wire transfer from the bank account associated with that card to the merchant's bank account.

Bank-to-bank wire transfer are considered the most secure and therefore more desirable than other forms of money transfer. In this fashion, wire transfers have become the most popular way to pay for online purchases.

Credit unions make a preferred third party for customer designated accounts, for easy wire transfers and for the diversity of investment options. When using a credit union third party wire transfers are permissible as directly deposited into an investment account. Credit unions can wire funds to and from their financial institution for deposit at Mid-Atlantic Corporate or the institution of their choice. Wires can also be conducted quickly and easily under the “Wire Transfer” section of Zephyr®.

With domestic third party wires, a credit union's members can transfer funds to any financial institution capable of receiving funds. Credit unions can wire finds to institutions for the purchase of investment options.

An international wire transfers funds from one financial institution to another across international boundaries. International wires are handled in the same way as third party wires. Funds can be sent in U.S. dollars or foreign currency.

Western Union's Quick Cash® Service enables credit unions to transfer funds to or on behalf of their members. Credit unions call Mid-Atlantic Corporate with their member's name and the amount needed. Mid-Atlantic Corporate enters the information into Western Union's Quick Cash® system. The funds are available within minutes at any of 35,000 Western Union locations worldwide.

For the protection of the customer, a verification process can be initiated to ensure the validity of the wire transfer request. One of the security steps taken on wire transfers that are received via phone or fax is a call back. The customer's signature and a faxed copy of his or her driver's license (POS swipe), or other identification, is also typically required. Additionally, the customer can verify the account information by using online banking.

A beneficiary is usually an individual or company and is the final recipient of a wire funds transfer. It appears on the wire transfer form under “Final Credit or Payment To . . . ” When filling in a wire transfer form, the beneficiary should not be confused with the receiving bank, credit union, third party bank, or financial service institution.

If the beneficiary's account is with a receiving bank or credit union on the “FEDLINE” system (Federal Reserve Funds Transfer System), the route the wire takes is straightforward. It goes to a beneficiary's account number at the receiving bank or credit union that the ABA number pertains to. However, not every beneficiary account resides at a “FEDLINE” bank or credit union. When this occurs, the receiving bank is asked to continue to route the wire finds to an additional destination where the beneficiary's account will be recognized. This is considered a “Third Party.”

An institution that maintains an account with a Federal Reserve Bank generally is allowed to be a Fedwire participant. These institutions include Federal Reserve member banks, non-member depository institutions, and certain other institutions, such as branches and agencies of foreign banks. The Board's Regulation J, subpart B, which incorporates Article 4A of the Uniform Commercial Code, and Operating Circular 6 (Funds Transfers through Fedwire), issued in accordance with Regulation J, govern Fedwire funds transfers. 8 Under Regulation J and Operating Circular 6, the Federal Reserve Banks can also impose conditions on an institution's use of Fedwire. In particular, Operating Circular 6 requires each Fedwire participant to enter into a security procedures agreement with its Federal Reserve Bank.

The EST system may utilize self contained, self service terminals/kiosks to accomplish various transactions related to the EST system via self-service. If desired, the EST system can adapt in-home store/bank integrated websites for customer access to internet-ready enrollment and activation. Whether at home or using the in-store terminal/kiosk, the customer opens a connection to a new or existing savings account, and registers and/or activates the selected identification method (i.e., CDL, existing or new loyalty card, debit card, etc.), which can link to the optional checking account.

Self-service kiosks within the merchant store can be provided with optional biometric security and/or encrypted digital signature/certificates for immediate use/activation and issue of an the EST system account and identification card. This can be accomplished through an optional private or centralized network and bank.

The use of maximum, biometric-enabled and/or other integrated security allows “instant issue” certificates for membership, card issuance, savings account, investments, insurance policies and premium payments, HSA accounts, rebates, etc. If partnered with credit unions and other qualified agents, they may act as a third party on behalf of customer to transact online, instant money wires online, investments, direct deposit into IRAs, college savings, stock purchases, etc. Registering online entitles customers to a guaranteed minimum savings account interest rate, typically without fees to customer.

Preferably, terminal applications are provided which allow customers to open a savings account online and without leaving the store, including register and/or printout their ID/user card. The card can be any of a number of accepted forms of identification, including drivers licenses, loyalty cards, reward cards, prepaid cash cards, debit cards or other cards with readable customer information.

The EST system can then link the card to the requisite accounts for immediate activation and use.

One advantage of the EST system is that the merchant and a designated bank can be easily and seamlessly integrated into the EST system template. Stores/banks pre-existing customer data bases remain separate, while the content is captured yet remains invisible until approved and activated by customer, creating a combined the EST system data base which is easily managed by the licensee and/or sub-licensee.

Whether the customer data base is managed by the merchant (licensee), the Bank (sub-licensee), another third party or visa-versa, the user friendly interface is practical for merchants and customers alike. The EST system message prompt variations (inviting customer to electronically transfer and save cash) is customized and/or selected by licensee (merchant, bank, processor, provider, etc). The ever-growing number of installed POS terminals and the continuous evolution of POS software applications have made terminal updates and maintenance, security and management key factors in the electronic payment market. Electronic message (savings prompt) represent a software adaptation that is easily downloaded and implemented. Compatible software for seamless integration into most of today's EPS is easily incorporated, without requiring additional hardware or installation costs for merchant

The EST system can be provided with a downloadable application and integration that will make it simple to implement and universally compatible, as well as being highly secure. The downloadable application may be based on the Windows operating system and open network EPS. The EST system's software designers, developers and system integrators may easily create any architecture for integration with most pre-existing terminals/structures, software and marketing programs, using techniques and programming strategies that are well known to the art.

As one example, the EST system can integrate EPS electronic payment systems with POS (in-stores or online) software that electronically submits customer rebate request s instantaneously and most often, simultaneously to the related purchase transaction. Rather than waiting weeks for the rebated check to arrive, participating merchants/manufacturers are able electronically transfer the funds into the customer's savings account (via money wire or store's existing ACH) In-store self service kiosks for the EST system may be made up of various standard elements and can be customized according to merchants. The main elements are the user interface and a database and communication module that can be installed either on a single merchant's (licensee) machine or on different machines connected to one or more various networks.

For further customer support, website links can be established to existing sites for bank, stores, affiliates, etc., may be provided.

Paperless e-cash payments and money wires reduce returned NSF checks and other problematic charge backs while increasing customer loyalty and helping to build stronger families and communities. The EST system works the same as writing a check or using the customer's debit card, but is the only electronics funds transfer (EFT) savings program that allows the customer to pay incremental amounts of CASH via electronic savings transfer. The customer's the EST system contributions will appear as on the customer's receipt as well as on the customer's bank statement. The easy two-step sign up process only takes a minute and then the customer are ready to start saving. The EST system represents the first EFT savings account that does not require the use/ownership of a checking account or credit card.

Further security can be provided in ways known to the art. Identities and accounts are validated through, for instance, the U.S. banking system and credit bureau, ensuring privacy and security. The EST system doesn't require the customer to fund a separate account or provide the customer's credit card information to online or in-store merchants. The customer simply completes a consumer registration form, opens the customer's savings account online or at a participating in-store bank, and the customer is ready to start saving money for the future. The customer's personal information is not shared with merchants, and the customer won't ever be asked for a credit card number or social security.

The customer can review all the customer's savings contributions made through the EST system at any time simply by visiting the customer's in-store bank or accessing online, simply by entering the customer's user name and password in the Customer Login box.

In any case, whether the customer registers and saves on a “per usage” basis or agrees to a regular savings contributions, the customer receives electronic prompts at the electronic payment system similar to “cash back?” prompts. The prompts can be activated by card or cardless methods.

The EST system also lets the customer provide the cashier with cash, or have cash debited from the customer's checking account, accompanying the customers purchase. Cash transactions contemplated by this method include prepaid cash cards, e-checks, and even funds associated with store credits/vouchers/returns.

The customer may choose the customer's contribution amount from various options, but in such cases, the easiest option will be to round the customer's purchase up to the nearest dollar or increment of dollar amount. In response, the EST system electronically transfers the amount of the difference into the customer's designated account for the EST system. One side benefit of this is that the EST system will make it easier to balance the customer's checkbook.

The EST system can be set up so that family members and merchants can also contribute, particularly where the designated accounts are “deposit only” accounts. The EST system prompts and fund transfers can be programmed and seamlessly integrated into all open network/platform EPS machines (and other venues).

Loyalty cards and programs can also be customized around the EST system, such that depositors can use their drivers License, phone number, RFID, personal biometrics, contact and contactless cards, prepaid gift cards, re-loadable prepaid visa/debit cards, etc. In one approach, the designated account is a pooled trust account held for the customer's benefit at a chartered bank. All funds in a pooled trust account are held by the holder bank for the benefit of the customer. Unlike other rewards systems, the EST system does not take possession of or have any legal, beneficial or other rights to funds held in the pooled trust accounts. However, in the process of clearing transactions between customers and merchants, the merchant may have to be in possession of funds for short periods of time during the clearing process. It is clear, nevertheless, that the EST system is not a bank and the system provides a payment processing service rather than a banking service.

When a customer transfers funds from a POS transaction at a merchant location, the entire transaction amount will typically be debited from the user's checking account (both the sale price and the additional funds for deposit into the designated savings account). Normally, funds deposited into the customer's designated account from the customer's checking account will not be available until they clear through the banking system, which could take up to four business days. For ACH transactions, this could be one day for wire transfers and/or two days for in-house transfers.

Depending on the policies of the merchant, a customer may not be credited with the payment made to the merchant until the merchant has verified settlement of the funds. In most cases the merchant will credit the user's account instantly, and the user will have access to the goods and/or services being purchased.

The EST system includes integrations, processes, configurations and/or software to some or all (but not limited to) the following: account aggregation, bill presentment, charting, auto login, notifications, transaction categorization and reporting, financial advisor delegation/access, integrated financial software and infrastructure and downloads, high quality data feeds. Additional Account Aggregation products and services may include: data/usage per ISP, affinity sites and applications, smart card technologies, Ethernet, credit/debit card brokerage, ATM and processor products/services, ACH transfers, Account Opening and Funding, OFX Server, ID/PIN security and coding, built-in multi-bank branding capability and ASPs, functional and operational advantages, HTML scripts, direct feeds, gateway, high quality integration, the EST system data, data mining and database, Java Server; E-commerce and M-commerce, ATM/Debit. Internet PLUS wireless mobile networks; mobile communications, text and data transfers implementing General Packet Radio Service (GPRS) and the Universal Mobile Telecommunication fully function mobile application using WAP 4 an open, global standard for mobile solutions and connection mobile terminals to the internet. WAP based technology; interactive, real-time mobile/banking and account access/services (e.g., phones, PDA's Handheld PC's and other devices). WIM (Wireless Identity Module) stores cryptographic parameters and executing cryptographic algorithms. Plugged into socket in mobile phone handset, (different from socket reserved for SIM or combined functionality, namely SWIM. System (UMTS); UMTS part of 3G, third generation mobile communication with enhanced services compared to present's most common GSM network, Mobile applications referred to as added value services via wireless mobile network operator to subscribers in addition to basic service of voice communication. Customers may use keypad and display of mobile phone or mobile internet access devices to process EFT and/or wire services, and receive device-appropriate responses. Prompts may be include with 3G/GSM networks which allows subscribers to order and purchase goods per the invention while roaming, including on-line and offline, web mall etc., and make random deposits/payments, contributing to their savings. M-Commerce, STK/SMS technology; on and off line mobile banking, mobile find transfer and mobile payments for m-commerce, GSM network/aggregate via an SMS center, product-specific chip cards, configuration, software, downloads, SIM I (Subscriber Identity Module), STK 2 (Sim Application Toolkit). And, PP SMS 3 (Point-to-Point Short Message Service) off line, protocol with peer application will be programmed/networked for customer access/banking and new accounts, transfers off-line (secure) via text messaging feature.

Once monies have matured, the customer will have additional options and choices to rollover and/or invest The EST system savings into a higher yielding and/or qualified retirement plan. Professional and expert tax advisors and financial institutions will be amongst resources and referrals made available to the customer.

Independent Sales Organizations (ISO's) or members sponsored by an ATM member network/financial institutions and in-store bank can sell or up-sell EST payment options with any ATM or POS terminal. Networks are able to offer EST integration to merchants/retailers, banks, terminal processors and/or providers.

Network sponsor banks can be any depository financial institution that elects to sponsor a retailer into the network. The sponsorship can be through a direct contract that is held between the financial institution and the retailer, or through a contract that is held between the financial institution and an ISO. The sponsoring institution is responsible for ensuring the retailer is in compliance with network regulations, including accurate and properly placed network signage/decals. It is also responsible for any liability that may be associated with a network's EST PIN-secured debit transaction. This provides new customers and addition streams of revue to all involved.

By participating in the EST program, stores and banks will have an opportunity to cross market. One opportunity is through pre-registering and pre-linking their respective new and existing customers with a “pending activation” savings account (rewards card, debit card, etc.). This can provide the each with an immediate and new customer base while they cultivate their own. This cross-marketing can be achieved by “capturing” images/data from terminal data base to create or link another, without disclosing or exposing customer files, identity or compromising privacy or security concerns (customer are anonymous and separate until they opt to use the prompt and authorized activation. This capturing process is accomplished using smart cards (or similar) and readers without human intervention.

Merchants and third parties may even choose to participate in customers' retirement rewards by providing them cash incentives when using the visual terminal prompts and store-to-bank savings option. A prompt integrated system allows customers direct access to achieving future financial security. POS merchant terminals provide electronic visual prompts, downloaded and/or integrated into POS terminals, automatic teller machines, mobile phones, e-commerce and internet software applications, and/or voice prompted telebanking, etc., with the ability to link one card to multiple services, stores, merchants, accounts, etc.

Through software licensing, EST software permits downloading of “save cash” prompts online when shopping, internet-banking, opening an online bank, checking or savings account, online checkouts, ordering store rewards cards, etc. Through store and bank collaboration, customers may receive multi-media exposure and various automated reminders to save money, rather than just spend money, thus enabling them to electronically, directly and gradually build their own personal retirement/savings account. However, where the “Save Cash” option is transacted offline using a rewards cards and cash or prepaid card, the merchant typically avoids paying any processing and/or bank fees associated with debit/charge cards and is generating good will and customer loyalty.

One way an EST personal rewards program can differ from that of other customer rewards programs, (in addition to overall concept, process, method and outcome), is in the psychological and emotional appeal. Other programs promote, attract and retain customers based on probable rewards that are secondary and supplemental “perks” to shopping. EST system customers take precedence to shopping. The customer interest in savings is promoted first (through contributions of his/her own) and the merchant interest in selling products is secondary. The EST system customer is not a byproduct of the program, but a key component and definitive beneficiary of cash revenues. Other rewards programs such as escrip and UPromise actually promote the lack of savings and input required of the customer, who is rewarded for buying things that they were likely going to buy in any case. The EST system emphasizes the opposite, i.e., the importance, significance, and critical role that each and every customer plays and is required of them to partake.

As an example of a banking service, once a customer's designated account balance reaches a given amount, for example, $200.00, the bank's “personal financial and investment consultant may call the customer to educate the customer in ways to exercise higher yield rollover investment options, e.g., equity indexed annuities and universal life.

Similarly, after some period of time, for example, after 90 days, the customer may be invited to invest the EST funds into a pre-qualified, tax deferred sp500 equity-indexed annuity and universal life insurance account with a no-loss and minimal interest guarantee, flexible premiums, no penalty cash withdraws

An EST linked website can also provide a price comparison search engine to be used for retail price matching and customer cash accumulation. In fact, the actual transaction can occur online or in the merchant's store. Customers can bring proof/printout of price match from the website (or other resource) into participating stores for a cash credit to savings account. In addition to their own cash contributions, customers are able to save cash paid by the merchant, using the website's price matching method (aka, “merchant matching” application) or other resource/tangible proof.

For instance, the customer may search for a particular item using an online “price comparison search engine” (or other search engine such as froogle.com). The products' comparative price results are itemized and displayed—the customer then intentionally (pre-sale versus typical post-sale) purchases the item at the higher price from the higher priced merchant (a sale that would have otherwise been lost to the lower priced merchant). The price is then “matched” to meet the “lower priced leader” and then beat the lower priced merchant with an additional 5-20% cash “incentive” paid directly to the customer's savings account (via EFT; money wire or their existing in-store ACH).

Most major stores offer a minimum 14-day price guarantee, and provide customers with a pre or post-sale “best price” guarantee, which means they'll refund the price difference between what the customer paid and the sale price, plus up to 20 percent. Rather than paying that to the customer directly (or issuing a store voucher/credit), the merchants' cash and apparent philanthropist intentions and contributions are reversed- and paid into the customer's savings account. In-stores, swiping a driver's license is one of many ways to register and/or identify cash paying customers and link their savings account (and/or using an the EST system “deposit” versus the opposite debit card). Online, the savings account is pre-linked to our website, participating merchants' websites, affiliate programs, bank, and more. There are other websites that customers can reference for regularly updated retail price matching which include www.cairo.com (used in conjunction with our savings program); customers are able to track thousands of current advertised sale prices even after the purchase was made. An EST linked site may even e-mail customers if their referenced item sold for less by another merchant. This can greatly simplify the customer's often difficult and exhausting quest in the ongoing “price war” and easily prepare/pave the way for merchant price adjustments (in-store or online). These search engines could be used in addition to—or in lieu of—other online comparison search engines, which would simplify and help customers' for in-store transactions/credits, while merchants acquire new customers, retain existing customers' loyalty, win new revenues, new marketing venues and demographics, new competitive edge, and provide merchants with new and extensive online world-wide-web presence.

Similarly, the EST system can be adapted to allow store merchants the option to cash advance customer's manufacturer rebates and directly receive and retain the forthcoming rebate. Other affiliate websites offering current rebate information and pricing would be the greatest affiliates and customer resource.

Store merchants may opt to make a secondary cash contribution generated from in-store and/or online specials, rebates, promotions, rewards and/or other discounts. Or, returned merchandise or store credits may become the source of funds for EFT transfer to and EST customer designated account (e.g., possibly at a negotiated lower price for vouchers, in lieu of gift cards and/or returns without a receipt).

Merchants and/or banks can brand their own rebate and/or rewards card/program in conjunction with the EST system.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A method for directing the transfer of funds to a customer designated account at a electronic payment system terminal, said method comprising the steps of:
a) establishing a customer designated account capable of being accessed through the transaction processing system associated with a merchant, wherein said transaction processing system is communicatively linked to said customer designated account;
b) accessing identifying data relating to said customer designated account through an electronic payment system terminal communicatively linked to said transaction processing system;
c) automatically generating an electronic savings prompt for a customer at said electronic payment system terminal; and
d) in response to a positive customer input to said savings prompt establishing a connection to said customer designated account and transferring funds into said customer designated account.

2. The method of claim 1 wherein in step b) said electronic payment system terminal is a point of sale terminal at a merchant.

3. The method of claim 1 wherein in step b) said electronic payment system terminal is an ATM machine.

4. The method of claim 1 wherein in step d), said funds comprise a debit contribution from a personal account of said customer.

5. The method of claim 1 wherein in step d), said funds further comprise an incentive contribution from said merchant.

6. The method of claim 1 wherein in step d), said funds comprise a cash contribution.

7. The method of claim 6 wherein said cash contribution is in addition to a purchase price in a sales transaction between said customer and said merchant.

8. The method of claim 1 wherein in step a) connectivity to said customer designated account is established by electronic integration into software of said transaction processing system.

9. The method of claim 8 wherein electronic said software integration comprises software capable of being integrated into said transaction processing system.

10. The method of claim 8 wherein electronic said software integration comprises adapting software of said transaction processing system.

11. The method of claim 1 wherein in step b) said identifying data is located on a card selected from the group of cards consisting of ATM, driver' license, merchant loyalty card or a prepaid, reloadable VISA/MC.

12. The method of claim 1 wherein said customer designated account is an account at a bank having a branch within the merchant.

13. The method of claim 1 wherein said customer designated account is a savings account.

14. The method of claim 1 wherein said customer designated account is a retirement account.

15. The method of claim 14 wherein retirement account is selected from the group of accounts consisting of a 401K account, a 529 account, a mutual fund and an IRA account.

16. The method of claim 1 wherein said customer designated account is an account attached to a whole life insurance policy.

17. The method of claim 1 wherein in step a) establishing a customer designated account comprises pre-registering for said customer designated account via said merchant.

18. The method of claim 17 wherein registering for said customer designated account is in response to prompts generated at the point of sale.

19. The method of claim 1 wherein in step a) establishing a customer designated account comprises registering for said customer designated account via a bank.

20. The method of claim 1 wherein in step c) said prompt comprises an option of transferring s specific amount of money into said customer designated account.

21. The method of claim 1 wherein in step c) said prompt comprises an option of transferring a percentage of a transaction amount into said customer designated account.

22. The method of claim 14 wherein in step c) said percentage relates to the sales tax percentage for the transaction.

23. The method of claim 1 wherein in step c) said prompt comprises an option of transferring the difference between the transaction amount and a higher amount.

24. The method of claim 1 wherein in step c) said prompt comprises an option of transferring an amount according to a calculation method pre-selected by the customer at the time of establishing the customer designated account in a).

25. A system for directing the transfer of money to a customer designated account at a point of sale in response to a customer input directing such transfer, said system comprising:
a) a customer designated account capable of being accessed through the transaction processing system associated with a merchant, wherein said transaction processing system is communicatively linked to said customer designated account;
b) an electronic payment system terminal communicatively linked to said transaction processing system and capable of accessing identifying data relating to said customer designated account;
c) a system for generating an electronic savings prompt for a customer at said electronic payment system terminal; and
d) software capable of establishing a connection to said customer designated account and directing the transfer of funds into said customer designated account in response to a positive input by a customer to a savings prompt.

26. The system of claim 25 wherein in step b) said electronic payment system terminal is a point of sale terminal at a merchant.

27. The system of claim 25 wherein in step b) said electronic payment system terminal is an ATM machine.

28. The system of claim 25 wherein in step d), said funds comprise a debit contribution from a personal account of said customer.

29. The system of claim 25 wherein in step d), said funds further comprise an incentive contribution from said merchant.

30. The system of claim 25 wherein in step d), said funds comprise a cash contribution.

31. The system of claim 30 wherein said cash contribution is in addition to a purchase price in a sales transaction between said customer and said merchant.

32. The system of claim 25 wherein in step a) connectivity to said customer designated account is established by electronic integration into software of said transaction processing system.

33. The system of claim 32 wherein electronic said software integration comprises software capable of being integrated into said transaction processing system.

34. The system of claim 32 wherein electronic said software integration comprises adapting software of said transaction processing system.

35. The system of claim 25 wherein in step b) said identifying data is located on a card selected from the group of cards consisting of ATM, driver' license, merchant loyalty card or a prepaid, reloadable VISA/MC.

36. The system of claim 25 wherein said customer designated account is an account at a bank having a branch within the merchant.

37. The system of claim 25 wherein said customer designated account is a savings account.

38. The system of claim 25 wherein said customer designated account is a retirement account.

39. The system of claim 38 wherein retirement account is selected from the group of accounts consisting of a 401K account, a 529 account, a mutual find and an IRA account.

40. The system of claim 25 wherein said customer designated account is an account attached to a whole life insurance policy.

41. The system of claim 25 wherein in step a) establishing a customer designated account comprises pre-registering for said customer designated account via said merchant.

42. The system of claim 41 wherein registering for said customer designated account is in response to prompts generated at the point of sale.

43. The system of claim 25 wherein in step a) establishing a customer designated account comprises registering for said customer designated account via a bank.

44. The system of claim 25 wherein in step c) said prompt comprises an option of transferring s specific amount of money into said customer designated account.

45. The system of claim 25 wherein in step c) said prompt comprises an option of transferring a percentage of a transaction amount into said customer designated account.

46. The system of claim 45 wherein in step c) said percentage relates to the sales tax percentage for the transaction.

47. The system of claim 25 wherein in step c) said prompt comprises an option of transferring the difference between the transaction amount and a higher amount.

48. The system of claim 25 wherein in step c) said prompt comprises an option of transferring an amount according to a calculation system pre-selected by the customer at the time of establishing the customer designated account in a).
